(19) United States
(12) Patent Application Publication
(10) Pub. No.: US 2023/0153409 A1
(43) Pub. Date: May 18, 2023

(54) AUTHENTICATION SYSTEM, AUTHENTICATION METHOD, AND PROGRAM RECORDING MEDIUM

(71) Applicant: NEC Corporation, Minato-ku, Tokyo (JP)

(72) Inventors: Yuka OGINO, Tokyo (JP); Kosuke YOSHIMI, Tokyo (JP); Takahiro TOIZUMI, Tokyo (JP)

(73) Assignee: NEC Corporation, Minato-ku, Tokyo (JP)

(21) Appl. No.: 17/618,957

(22) PCT Filed: Oct. 11, 2021
(86) PCT No.: PCT/JP2021/037514

§ 371 Date: Dec. 14, 2021

(30) Foreign Application Priority Data
Oct. 16, 2020 (JP) 2020-174754

(51) Int. Cl. G06F 21/32

(52) U.S. Cl. CPC G06F 21/32

(57) ABSTRACT

In an authentication system, a storage unit of an authentication device constituting the authentication system stores an identification model in order to reduce a risk of leakage of personal information and shorten a response time of an authentication process. The identification model is a model generated by learning a feature amount extracted from biometric information of a registrant. A determination unit of the authentication device determines whether to authenticate a person to be authenticated based on a feature amount extracted from biometric information of the person to be authenticated using the identification model of the storage unit. A storage unit of a server constituting the authentication system stores the same identification model as the identification model used by the authentication device. An update unit of the server updates the identification model of the storage unit in response to a change of the registrant. A transmission unit transmits update information of the identification model to the authentication device in response to the update of the identification model.

### TECHNICAL FIELD

The disclosure relates to a technique for biometric authentication using biometric information.

### BACKGROUND ART

In biometric authentication using biometric information, such as a face, a fingerprint, an iris, and a vein pattern of a finger, a palm, or a back of a hand, which are features of a person, for example, a feature amount extracted from biometric information of a person to be authenticated is compared with a feature amount of biometric information of a registrant registered in advance. When the feature amount of the person to be authenticated matches the feature amount of the registrant through this comparison, the person to be authenticated is authenticated as the registrant.

Such an authentication process of determining whether to authenticate the person to be authenticated by comparing the biometric information may be performed by a computer device (hereinafter, also referred to as a local device) that acquires the biometric information of the person to be authenticated or may be performed by a server connected to the local device.

PTL 1 (JP 2020-24647 A) discloses a security system including control devices arranged at bases and a central management device to which the control devices are commonly connected. In this security system, a master in which pieces of user information of all system users are registered is provided in the central management device, and each of the control devices includes a user information table including some of the pieces of the user information. Each of the control devices collates personal authentication information read by an authentication machine with information in the user information table to perform user authentication of a user.

### CITATION LIST

### Patent Literature

### [PTL 1] JP 2020-24647 A

### SUMMARY OF INVENTION

### Technical Problem

In a case where the local device executes the authentication process by comparing the biometric information of the person to be authenticated with the biometric information of the registrant, for example, the local device is provided with a database in which personal information that can identify the registrant and the biometric information of the registrant are saved. There is a case where the security of the local device is weaker than that of the server, and in such a case, a risk that the personal information leaks from the database is higher as compared with a case where the database is provided in the server.

On the other hand, in a case where the server executes the authentication process, it is necessary to transmit the biometric information, acquired from the person to be authenticated by the local device, from the local device to the server. During such transmission, the information to be transmitted is encrypted by the local device as a measure against information leakage. As a result, time for the encryption processing is also required in addition to time for communication of the biometric information, and thus, there arises a problem that a response time of the authentication process from acquisition of the biometric information of the person to be authenticated to notification of a determination result of the authentication process with respect to the person to be authenticated becomes long.

This disclosure has been devised in order to solve the above problems. That is, the main object of this disclosure is to provide a technique for reducing a risk of leakage of personal information and shortening a response time of an authentication process.

### Solution to Problem

In order to achieve the above object, an authentication system, as one aspect thereof, includes:

an authentication device including a storage unit that stores an identification model generated by learning a feature amount extracted from biometric information of a registrant, a determination unit that determines whether to authenticate a person to be authenticated using the identification model based on a feature amount extracted from biometric information of the person to be authenticated, and an output unit that outputs a determination result of the determination unit; and

a server including a storage unit that stores the same identification model as the identification model used by the authentication device, an update unit that updates the identification model in response to a change of the registrant, and a transmission unit that transmits update information of the identification model to the authentication device.

Further, an authentication method executed by a computer, as one aspect thereof, includes:

updating identification model identical to the identification model used by an authentication device that determines whether to authenticate a person to be authenticated based on a feature amount extracted from biometric information of the person to be authenticated using the identification model generated by learning a feature amount extracted from biometric information of a registrant, in response to a change of the registrant;

transmitting update information of the identification model to the authentication device; and

causing the identification model to be updated based on the update information in the authentication device that has received the update information of the identification model and the authentication device to determine whether to authenticate the person to be authenticated based on the feature amount extracted from biometric information of the person to be authenticated using the updated identification model.

Further, a program storage medium, as one aspect thereof, stores a computer program that causes a computer to execute:

a process of updating an identification model identical to an identification model used by an authentication device that determines whether to authenticate a person to be authenticated based on a feature amount extracted from biometric information of the person to be authenticated using the identification model generated by learning a feature amount extracted from biometric information of a registrant in response to a change of the registrant; and

a process of transmitting update information of the identification model to the authentication device.

### BRIEF DESCRIPTION OF DRAWINGS

FIG. 1 is a block diagram illustrating functional configurations of an authentication system according to a first example embodiment.

FIG. 2 is a diagram illustrating an example of hardware configurations of an authentication device and a server.

FIG. 3 is a flowchart illustrating an operation example regarding update of an identification model in the server.

FIG. 4 is a flowchart illustrating an operation example regarding update of an identification model in the authentication device.

FIG. 5 is a diagram illustrating an authentication system according to a second example embodiment.

FIG. 6 is a diagram illustrating an authentication system according to a third example embodiment.

FIG. 7 is a diagram illustrating an authentication system according to other example embodiments.

FIG. 8 is a flowchart illustrating an operation example regarding update of an identification model in the authentication system according to other example embodiments.

### EXAMPLE EMBODIMENT

Hereinafter, example embodiments according to the disclosure will be described with reference to the drawings.

### First Example Embodiment

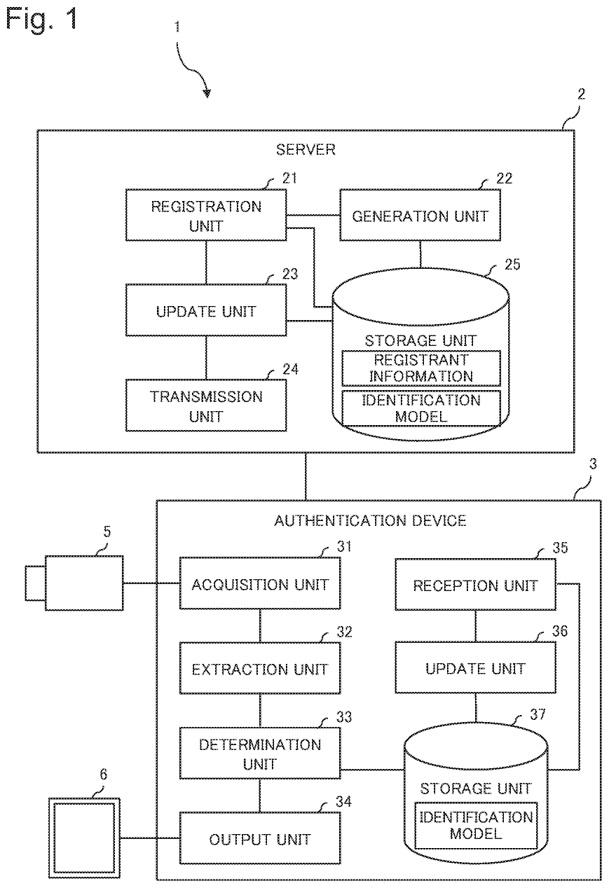

FIG. 1 is a block diagram illustrating functional configurations of an authentication system according to a first example embodiment. An authentication system 1 of the first example embodiment is a system that includes a server 2 and an authentication device 3, and determines, for example, entry permissibility with respect to a facility by biometric authentication. The biometric authentication is authentication that uses biometric information indicating physical features and behavioral features of a person. Examples of the biometric information include a face, a fingerprint, an iris, a vein pattern, a voiceprint, a palm print, an eyeball blood vessel pattern, a shape of an auricle, a habit of a way of walking, and the like.

The server 2 includes, as functional units, a registration unit 21, a generation unit 22, an update unit 23, a transmission unit 24, and a storage unit 25.

The storage unit 25 stores (saves) various types of data and computer programs (hereinafter, also referred to as programs). The storage unit 25 is enabled by a storage medium that stores data and programs. There are various types of storage media such as a magnetic disk and a semiconductor memory, but the storage unit 25 may include any type of storage medium. The storage medium forming the storage unit 25 is not limited to one type, and the storage unit 25 may be constituted by a plurality of types of storage media.

In the first example embodiment, at least registrant information and identification model are saved in the storage unit 25. The registrant information is information related to a user (hereinafter, also referred to as a registrant) determined in advance to permit entry. For example, the registrant information includes registrant identification information (user identification (ID)) for identifying the registrant, personal information of the registrant, and history information of a result of determination on the entry permissibility obtained by the authentication system 1. Further, the registrant information also includes, for example, an image of an iris of the registrant as the biometric information and information of a feature amount extracted from the image of the iris. The personal information is information that can identify a person by combining one or a plurality of pieces of information, and includes, for example, a name, an address, a telephone number, an organization name, a face photograph, and the like.

The identification model is a model that is generated by machine learning of biometric information acquired from a person to be authenticated and is used to determine whether the person to be authenticated is permitted to enter. The identification model does not include the personal information.

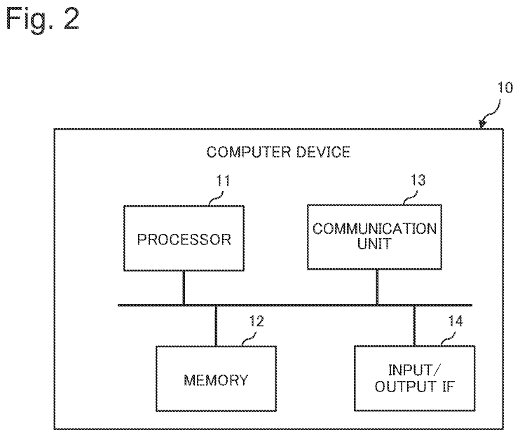

The registration unit 21, the generation unit 22, the update unit 23, and the transmission unit 24 are enabled by a computer device. FIG. 2 is a block diagram illustrating an example of hardware configurations of the computer device in a simplified manner. A computer device 10 includes, for example, a processor 11, a memory 12, a communication unit 13, and an input/output interface (IF) 14. The communication unit 13 enables communication with other devices such as the authentication device 3 via, for example, an information communication network (not illustrated). The input/output IF 14 enables, for example, communication of information (a signal) with an input device (not illustrated), such as a keyboard through which an operator of the device inputs information, a display device, and the like. The memory 12 is a storage medium that saves data and computer programs (programs). There are various types of storage media, and a plurality of types of storage media may be mounted on one device, but the storage media are collectively illustrated as one memory herein. The processor 11 is an arithmetic circuit that reads a program saved in the memory 12 and executes the program to control an operation of the computer device 10. The processor 11 enables the functional units of the registration unit 21, the generation unit 22, the update unit 23, and the transmission unit 24. Here, as the processor 11, one of a central processing unit (CPU), a graphics processing unit (GPU), a field-programmable gate array (FPGA), a demand-side platform (DSP), and an application specific integrated circuit (ASIC) may be used, or a plurality of them may be used in parallel.

The registration unit 21 receives registrant information input to the server 2 and saves the registrant information in the storage unit 25. The input of the registrant information to the server 2 may be performed by operating an input device connected to the server 2 or may be transmitted from another device to the server 2.

The registration unit 21 not only saves new registrant information in the storage unit 25, but also saves registrant information in the storage unit 25 in a case of receiving the registrant information of a registrant whose registrant information has already been saved in the storage unit 25. In this case, for example, the registration unit 21 saves the received registrant information to be overwritten on the already-saved registrant information of the same registrant.

Further, when receiving a deletion command to delete registrant information, the registration unit 21 deletes the registrant information to be deleted from the storage unit 25 based on, for example, a user ID that represents the registrant information to be deleted and has been received together with the deletion command.

The generation unit 22 generates the identification model by machine learning using the biometric information included in the registrant information. As described above, the identification model is the model used to determine whether the person to be authenticated is permitted to enter based on the biometric information acquired from the person to be authenticated.

For example, the generation unit 22 generates the identification model by performing machine learning of a feature amount, extracted from an image in which biometric information (for example, an iris) of a registrant is captured, as information regarding the possibility of entry, and saves the generated identification model in the storage unit 25. There are various techniques for generating the identification model by the machine learning, and a technique appropriately selected in consideration of a type of biometric information used for determination on the entry permissibility is adopted as a generation technique of the identification model. As an example of the generation technique, a technique of generating a nonlinear classifier by learning can be used. A feature amount extracted from an image or the like in which biometric information is captured is also referred to as the biometric information in some cases.

In a case where there is a change of the registrant information in the storage unit 25 as new registrant information is saved in the storage unit 25 or the registrant information is deleted from the storage unit 25 by the registration unit 21, the update unit 23 relearns the identification model based on the changed registrant information in the storage unit 25. Then, the update unit 23 saves the identification model generated by the relearning in the storage unit 25 as the updated identification model.

The transmission unit 24 transmits the identification model generated by the generation unit 22 to the authentication device 3. When the identification model is relearned and updated by the update unit 23, the transmission unit 24 transmits update information of the identification model to the authentication device 3. The update information of the identification model may be the updated identification model itself, or may be information indicating an updated portion of the identification model in consideration of the amount of communication and a time required for communication from the server 2 to the authentication device 3. For example, the transmission unit 24 compares the updated identification model with the identification model before the update, and transmits an updated parameter among a plurality of parameters included in the identification model to the authentication device 3 as the update information of the identification model. A timing when the transmission unit 24 transmits the update information of the identification model to the authentication device 3 is, for example, a timing when a transmission request for the update information is received from the authentication device 3 in a midnight time zone when an operating rate of the authentication device 3 is low. When receiving the transmission request, the transmission unit 24 transmits untransmitted update information of the identification model to the authentication device 3 in a case where there is the untransmitted update information of the identification model, and the transmission unit 24 does not perform the transmitting operation in a case where there is no untransmitted update information of the identification model.

The authentication device 3 is a device that determines whether a person to be authenticated is permitted to enter a facility based on biometric information acquired from the person to be authenticated using the identification model. The authentication device 3 is connected to an acquisition device 5 and a notification device 6. The acquisition device 5 is a device that acquires the biometric information of the person to be authenticated, and has a configuration in accordance with biometric information to be acquired. For example, in a case where the biometric information to be acquired is an iris, a fingerprint, a vein pattern, a palm print, a face, and a shape of an auricle, the acquisition device 5 includes, for example, a device including an image capturing device that captures them. Further, in a case where the biometric information to be acquired is a voiceprint, the acquisition device 5 includes, for example, a sound collection device (microphone) that captures a voice.

The notification device 6 is a device that visually, audibly, or visually and audibly notifies a determination result of the authentication device 3, and includes, for example, a display device equipped with a speaker.

The authentication device 3 includes, as functional units, an acquisition unit 31, an extraction unit 32, a determination unit 33, an output unit 34, a reception unit 35, an update unit 36, and a storage unit 37. The storage unit 37 stores various types of data and computer programs. The storage unit 37 is enabled by a storage medium that stores data and programs. There are various types of storage media such as a magnetic disk and a semiconductor memory, but the storage unit 37 may include any type of storage medium. The storage medium constituting the storage unit 37 is not limited to one type, and the storage unit 37 may be constituted by a plurality of types of storage media.

The storage unit 37 saves the identification model transmitted from the server 2.

The acquisition unit 31, the extraction unit 32, the determination unit 33, the output unit 34, the reception unit 35, and the update unit 36 are enabled by, for example, the processor 11 of the computer device as illustrated in FIG. 2.

The reception unit 35 receives the identification model transmitted from the server 2 and saves the identification model in the storage unit 37. The reception unit 35 receives the update information of the identification model transmitted from the server 2. When the reception unit 35 receives the update information of the identification model, the update unit 36 updates the identification model of the storage unit 37 based on the received update information of the identification model.

The acquisition unit 31 acquires the biometric information of the person to be authenticated output from the acquisition device 5. A mode of the biometric information acquired by the acquisition unit 31 is a mode in accordance with the acquisition device 5, such as an image in a case where the acquisition device 5 is an image capturing device, and an electric signal in accordance with a voice, for example, in a case where the acquisition device 5 is a microphone.

The extraction unit 32 extracts a feature amount from the biometric information acquired by the acquisition unit 31. There are various techniques as feature amount extraction techniques, and a feature amount extraction technique appropriately selected in consideration of a mode of biometric information (an image, an electric signal, or the like), a type of biometric information (for example, an iris, a vein pattern, or a voice), and the like is adopted here, and a description of the feature amount extraction method is omitted.

The determination unit 33 determines whether the person to be authenticated is permitted to enter (entry permissibility) based on the feature amount of the person to be authenticated extracted from the biometric information using the identification model of the storage unit 37. In other words, the determination unit 33 determines whether to authenticate the person to be authenticated.

The output unit 34 outputs information on a determination result of the determination unit 33 to, for example, the notification device 6 or an entry management system (not illustrated) of the facility connected to the authentication system 1. The notification device 6 that has received the information on the determination result notifies the person to be authenticated of the determination result. For example, when receiving information of “authenticated (authenticatable)” as the determination result from the authentication device 3, the entry management system of the facility executes a device operation of permitting entry such as raising a bar at an entrance and unlocking a door at the entrance.

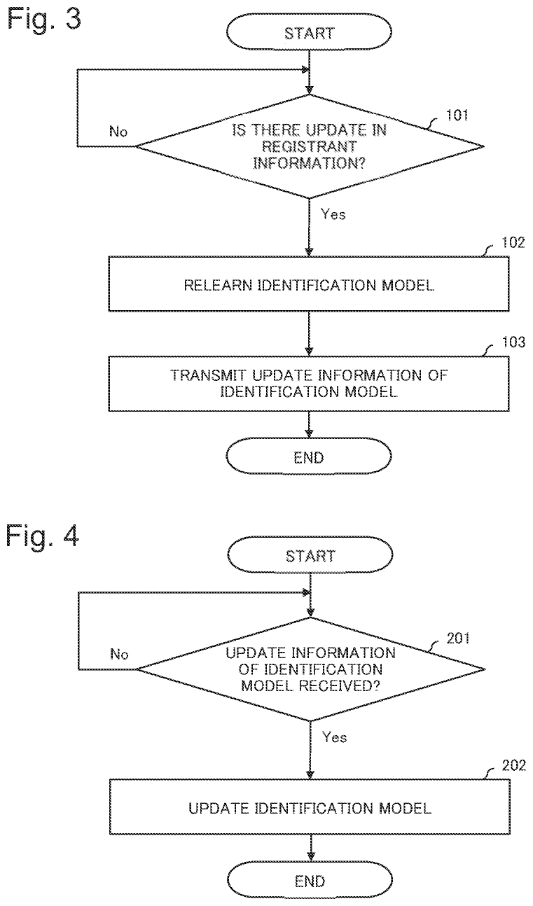

The authentication system 1 of the first example embodiment is configured as described above. Next, an example of an operation of updating the identification model in the authentication system 1 will be described with reference to FIGS. 3 and 4. FIG. 3 is a flowchart illustrating an example of an operation related to update of the identification model in the server 2. FIG. 4 is a flowchart illustrating an example of an operation related to update of the identification model in the authentication device 3.

For example, the update unit 23 of the server 2 determines whether there is a change in the registrant information based on an operation of the registration unit 21 in a state where the identification model is saved in each of the storage unit 25 of the server 2 and the storage unit 37 of the authentication device 3 (Step 101 in FIG. 3). As a result, when determining that there is no change in the registrant information, the update unit 23 repeats the determination operation of Step 101. When determining that there is a change in the registrant information, the update unit 23 relearns the identification model based on the changed registrant information in the storage unit 25 in response to the change such as addition or deletion of the registrant information (Step 102). Then, the update unit 23 saves the identification model generated by the relearning in the storage unit 25 as an updated identification model. Thereafter, the transmission unit 24 compares the identification model before the update with the updated identification model, and transmits the updated parameter in the identification model as the update information of the identification model to the authentication device 3 (Step 103).

In the authentication device 3, for example, the update unit 36 determines whether the update information of the identification model is received from the server 2 based on an operation of the reception unit 35 (Step 201 in FIG. 4). When the update information of the identification model is not received, the update unit 36 repeats the determination operation of Step 201. When the update information of the identification model is received, the update unit 36 updates the identification model in the storage unit 37 based on the received update information (Step 202).

Through such operations of the server 2 and the authentication device 3, the identification models in the storage unit 25 of the server 2 and the storage unit 37 of the authentication device 3 are updated.

Since the authentication system 1 of the first example embodiment has the above-described configuration, the following effects can be obtained. That is, in the authentication system 1, the authentication device 3 has the identification model, and the determination unit 33 of the authentication device 3 determines whether to authenticate the person to be authenticated using the identification model. As a result, the authentication system 1 does not need to transmit the biometric information of the person to be authenticated from the authentication device 3 to the server 2 in order to determine whether to authenticate the person to be authenticated. Thus, the authentication system 1 can reduce a response time from the acquisition of the biometric information of the person to be authenticated to the output of the determination result of the authentication process from the authentication device 3 as compared with a case where the biometric information of the person to be authenticated needs to be transmitted from the authentication device 3 to the server 2.

In the authentication system 1, the authentication device 3 (in other words, a local device) that acquires the biometric information of the person to be authenticated does not have the personal information with which the registrant can be identified. Thus, the authentication system 1 can suppress a problem that the personal information is leaked from the authentication device 3.

In the authentication system 1, the server 2 has the registrant information including the personal information, and the update unit 23 of the server 2 updates the identification model when there is a change in the registrant information in the storage unit 25 of the server 2. Then, the update information of the identification model is transmitted from the server 2 to the authentication device 3, whereby the identification model in the authentication device 3 is updated. That is, since the personal information of the registrant is not included in the identification model and the update information of the identification model transmitted from the server 2 to the authentication device 3, the authentication system 1 can suppress the leakage of the personal information even in the communication between the server 2 and the authentication device 3 performed by the process of updating the identification model.

Accordingly, the authentication system 1 can reduce a risk of leakage of the personal information and shorten the response time of the authentication process.

In a case where an iris is acquired as the biometric information and used for the authentication process, a clear difference in the biometric information is easily obtained as compared with a case where a fingerprint or a vein pattern is acquired as the biometric information and used, and thus, the accuracy of the determination by the authentication process can be improved.

The biometric information used for the authentication process may be plural, for example, an iris and a face. In such a case, for example, the generation unit 22 of the server 2 generates the identification model by performing machine learning of a plurality of feature amounts including a feature amount extracted from an image in which the iris is captured and a feature amount extracted from an image in which the face is imaged as information indicating the possibility of entry. The generated identification model is a model that outputs a result of determination on whether the person to be authenticated is permitted to enter based on the plurality of feature amounts of the iris and the face that are pieces of the biometric information. When the plurality of pieces of biometric information is used as described above, a plurality of types of acquisition devices acquiring the pieces of biometric information are provided as the acquisition device 5. The plurality of types of acquisition devices may be aggregated to have a mode as one device, or may be separate devices. As an example of a combination of the plurality of pieces of biometric information used for the authentication process, a plurality of pieces of biometric information such as an iris of a right eye and an iris of a left eye can also be exemplified.

In the example illustrated in FIG. 1, the single authentication device 3 is connected to the server 2, but a plurality of the authentication devices 3 may be connected to the server 2. In a case where registrants who are permitted to enter are the same in the plurality of authentication devices 3 connected to the server 2, an identification model common to the authentication devices 3 is generated by the generation unit 22 of the server 2, and the identification model is transmitted to the authentication devices 3. In a case where there is a change in the registrant information in the server 2, the update unit 23 of the server 2 updates the identification model, update information of the identification model is transmitted to the authentication devices 3 by the transmission unit 24, and the identification model in each of the authentication devices 3 is updated by the update unit 36.

In a case where registrants who are permitted to enter are different among the plurality of authentication devices 3 connected to the server 2, a device group information of registrant information related to each of the authentication devices 3 is generated. For example, identification information (hereinafter, also referred to as a device identification (ID)) of the related authentication device 3 is associated with the device group information of the registrant information. The generation unit 22 of the server 2 refers to the device group information of the registrant information, and generates an identification model related to each of the authentication devices 3 using the registrant information related to each of the authentication devices 3. For example, the device ID is associated with the generated identification model. The transmission unit 24 transmits the identification model to the related authentication device 3 using the device ID.

In the case where there is a change in registrant information, the update unit 23 of the server 2 updates an identification model associated with a device ID that is the same as a device ID associated with device group information of the changed registrant information using the updated registrant information. Then, the transmission unit 24 transmits update information of the identification model to the authentication device 3 that requires update of the identification model using the device ID, and the update unit 36 of the authentication device 3 that has received the update information of the identification model updates the identification model in the storage unit 37.

### Second Example Embodiment

Hereinafter, a second example embodiment will be described. In a description of the second example embodiment, portions with the same names as constituent portions constituting the authentication system of the first example embodiment will be denoted by the same reference signs, and redundant descriptions of such common portions will be omitted.

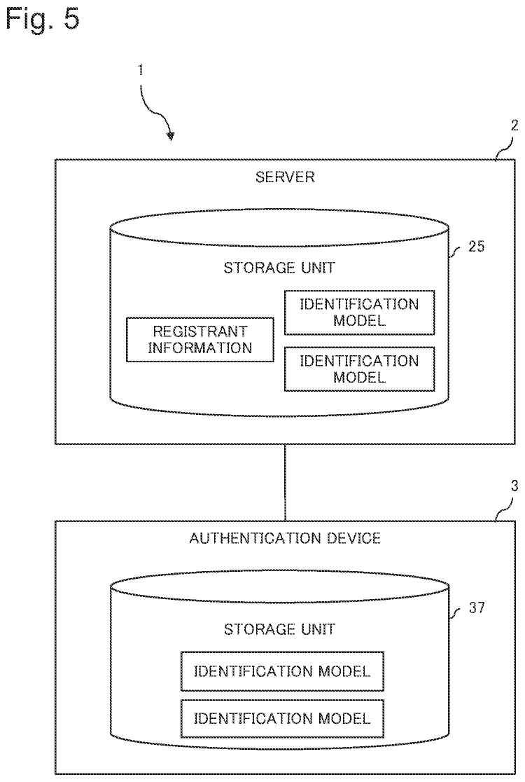

In the authentication system 1 of the second example embodiment, a plurality of identification models are saved in the storage unit 37 of the authentication device 3 as illustrated in FIG. 5. These identification models are models in which pieces of registrant information used in learning at the time of generating the models are different from each other. Such a configuration is particularly effective in a case where the number of registrants permitted to enter by the authentication device 3 is large. FIG. 5 does not illustrate the registration unit 21, the generation unit 22, the update unit 23, and the transmission unit 24 in the server 2, and the acquisition unit 31, the extraction unit 32, the determination unit 33, the output unit 34, the reception unit 35, and the update unit 36 in the authentication device 3 in the authentication system 1.

That is, in the second example embodiment, the pieces of registrant information related to the plurality of registrants permitted to enter by the authentication device 3 are classified into a plurality of pieces, and the pieces of classified information are associated with the pieces of registrant information in the server 2. A classification technique for classifying the pieces of registrant information is not limited, and for example, the pieces of registrant information may be classified for each organization, or the pieces of registrant information may be classified for each predetermined number in the order of registration. The pieces of registrant information may be classified for each age group such as under teens, teens, twenties, . . . , and seventies or over, or may be classified by gender.

In the storage unit 25 of the server 2, an identification model, generated by learning pieces of registrant information associated with the same classified information by the generation unit 22, is generated and saved for each classification of the pieces of registrant information. The classified information of the related registrant information is associated with the identification model.

In the storage unit 37 of the authentication device 3, a plurality of the identification models generated for the classifications of the pieces of registrant information are saved similarly to the storage unit 25 of the server 2. The identification model in the storage unit 37 is also associated with the classified information of the related registrant information.

The determination unit 33 of the authentication device 3 uses the plurality of identification models in the storage unit 37 in parallel to determine whether a person to be authenticated is permitted to enter (entry permissibility) based on a feature amount of the person to be authenticated extracted from biometric information.

In the second example embodiment, in a case where there is a change in registrant information of the server 2, the update unit 23 of the server 2 relearns registrant information associated with classified information related to a classification of the changed registrant information, thereby updating an identification model associated with the classified information. The transmission unit 24 of the server 2 transmits update information of the identification model to the authentication device 3 in response to the update of the identification model. The transmitted update information of the identification model is also associated with the related classified information.

The update unit 36 of the authentication device 3 updates an identification model associated with classified information that is the same as classified information associated with the update information of the identification model based on the received update information of the identification model.

Configurations of the authentication system of the second example embodiment other than the above are similar to the configurations of the authentication system of the first example embodiment, and the description thereof will be omitted here.

Since the authentication system 1 of the second example embodiment has the above-described configuration, the following effects can be obtained. That is, an effect similar to that of the first example embodiment can be obtained since the authentication system 1 of the second example embodiment has the configurations similar to those of the first example embodiment. In addition, in the second example embodiment, the plurality of identification models in which the pieces of registrant information used for learning when being generated are different each other are saved in the storage unit 37 of the authentication device 3, and the determination unit 33 executes determination processing using the plurality of identification models in parallel. As a result, the authentication system 1 can suppress a problem that a response time of an authentication process becomes long even when the number of registrants increases.

Further, in the second example embodiment, it is sufficient to update the identification model related to the classification of the changed registrant information, and it is unnecessary to change the identification model related to the other classification when there is a change in the registrant information of the server 2. Thus, the authentication system 1 of the second example embodiment can suppress a problem that it takes time to update the identification model due to a large number of pieces of the registrant information.

### Third Example Embodiment

Hereinafter, a third example embodiment will be described. In a description of the third example embodiment, portions with the same names as constituent portions constituting the authentication systems of the first and second example embodiments will be denoted by the same reference signs, and redundant descriptions of such common portions will be omitted.

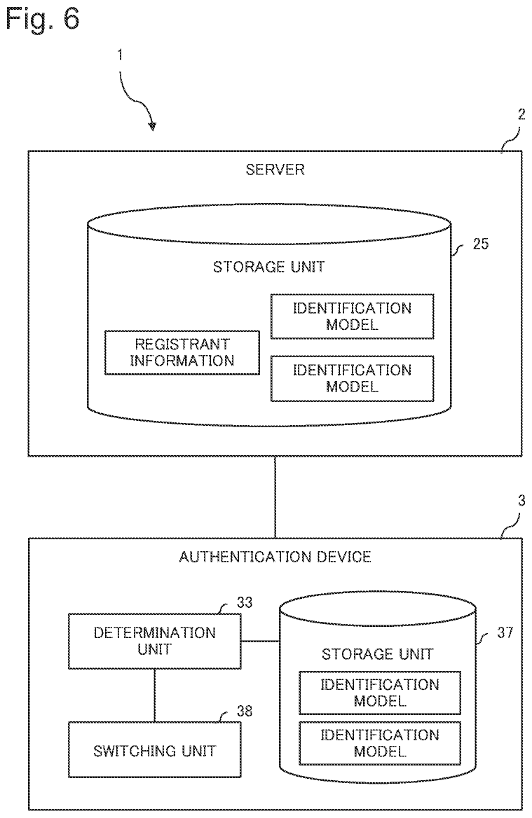

In the authentication system 1 of the third example embodiment, the authentication device 3 includes a switching unit 38 in addition to the configurations of the first and second example embodiments as illustrated in FIG. 6. The switching unit 38 is enabled by, for example, the processor 11 of the computer device 10.

The authentication system 1 of the third example embodiment has a configuration related to a case where a registrant who is permitted to enter varies depending on a day of the week and a time zone.

For example, information such as a day of the week and a time zone when entry is permitted is associated, as attribute information, with registrant information in the server 2. In the storage unit 25 of the server 2, an identification model, generated by learning pieces of registrant information associated with the same attribute information by the generation unit 22, is generated and saved for each attribute. The identification model is associated with the related attribute information.

In the storage unit 37 of the authentication device 3, a plurality of the identification models generated for attributes are saved similarly to the storage unit 25 of the server 2. The identification model in the storage unit 37 is also associated with the related attribute information. The plurality of identification models are used by the determination unit 33 in mutually different periods.

The switching unit 38 acquires time information, which is information for determining the attribute (for example, information on a day of the week or time), from a clock device built in the authentication device 3, for example, and outputs attribute information of an identification model to be used for an authentication process to the determination unit 33.

The determination unit 33 of the authentication device 3 uses the identification model in the storage unit 37 associated with the attribute information received from the switching unit 38 to determine whether a person to be authenticated is permitted to enter (entry permissibility) based on a feature amount of the person to be authenticated extracted from biometric information.

In the third example embodiment, when there is a change in the registrant information of the server 2, the update unit 23 updates an identification model associated with attribute information that is the same as attribute information associated with new registrant information or deleted registrant information by relearning the changed registrant information. The transmission unit 24 of the server 2 transmits update information of the identification model to the authentication device 3 in response to the update of the identification model. The transmitted update information of the identification model is also associated with the related attribute information.

The update unit 36 of the authentication device 3 updates an identification model associated with attribute information that is the same as attribute information associated with the update information of the identification model based on the received update information of the identification model.

Configurations of the authentication system of the third example embodiment other than the above are similar to the configurations of the authentication system of the first or second example embodiment, and the description thereof will be omitted here.

Since the authentication system 1 of the third example embodiment has the above-described configuration, the following effects can be obtained. That is, an effect similar to those of the first and second example embodiments can be obtained since the authentication system 1 of the third example embodiment also has the configurations similar to those of the first and second example embodiments. In the third example embodiment, the identification model depending on the day of the week or the time zone is saved in the authentication device 3, and the authentication device 3 includes the switching unit 38 that switches the identification model to be used for the authentication process depending on the day of the week or the time zone. Thus, the authentication system 1 of the third example embodiment can cope with a case where the registrant who is permitted to enter changes depending on the day of the week or the time zone.

As the switching of the identification model to be used in the authentication process, the following control for switching the identification model may be performed by the switching unit 38. For example, in the storage unit 25 of the server 2, registrant information of a normal registrant permitted to enter a facility for a predetermined period (for example, half a year or one year) and registrant information of a temporary registrant (scheduled visitor) permitted to temporarily enter the facility on a daily basis or a time basis are saved as the registrant information. In such a case, the registrant information includes, as the attribute information, information indicating either the normal registrant or the temporary registrant, and information on a time zone when entry is permitted in the case of the temporary registrant (for example, an entry-scheduled time zone such as 10 o'clock to 15 o'clock on ZZ, YY, 20XX).

The generation unit 22 generates an identification model for normal use by machine learning using biometric information included in the registrant information of the normal registrant. Further, the generation unit 22 uses the attribute information indicating the time zone (hereinafter, also referred to as a permitted time zone) when entry is permitted, included in the registrant information of the temporary registrant, to read biometric information of the temporary registrant having the same permitted time zone from the storage unit 25. Then, the generation unit 22 generates an identification model for temporary use by machine learning for each permitted time zone. The identification model for normal use and the identification model for temporary use generated by the generation unit 22 in this manner are associated with, for example, the same attribute information as the attribute information included in the registrant information.

The identification model for normal use and the identification model for temporary use are transmitted to the authentication device 3 by the transmission unit 24, and are saved in the storage unit 37 by the reception unit 35. The switching unit 38 of the authentication device 3 acquires time information (information on date or time), which is information for determining an attribute for switching of the identification model for temporary use, from the clock device of the authentication device 3, for example, and outputs attribute information related to the acquired time information to the determination unit 33. The determination unit 33 determines whether a person to be authenticated is permitted to enter (entry permissibility) using the identification model for normal use saved in storage unit 37 and the identification model for temporary use associated with the attribute information received from the switching unit 38 depending on a date or a time zone when a scheduled visitor is to visit.

In a case where the normal registrant varies depending on a day of the week or a time zone as described above, an identification model for each attribute, such as the day of the week and the time zone, as described above may be generated as the identification model for normal use and saved in the storage unit 37. In such a case, the switching unit 38 outputs attribute information depending on the day of the week or the time zone to the determination unit 33 in order to switch the identification model for normal use to be used for the authentication process in the same manner as described above. As a result, the identification model for normal use to be used by the determination unit 33 for the authentication process may be configured to switch depending on the day of the week or the time zone. That is, the identification model to be used by the determination unit 33 for the authentication process may be configured in such a way that both the identification model for normal use and the identification model for temporary use are switched.

Considered is a case where a time zone when a temporary registrant is permitted to enter is limited to 11 o'clock to 14 o'clock in a day or a case where the number of scheduled visitors who are temporarily permitted to enter is as small as about five in a day. In such a case, the following identification model may be generated. That is, as an identification model related to a time zone when the temporary registrant is scheduled to visit, an identification model based on pieces of biometric information of a normal registrant and the temporary registrant permitted to enter in the time zone may be generated. Then, an identification model to be used by the determination unit 33 may be switched in such a way that the identification model based on the normal registrant and the temporary registrant is used by the determination unit 33 in the time zone, and the identification model for normal use based on the normal registrant is used by the determination unit 33 in the other time zones. Such switching of the identification model can also be controlled by the switching unit 38 using the attribute information in the same manner as described above.

The time zone related to the switching of the identification model may be appropriately set in consideration of visit time of the scheduled visitor who is the temporary registrant. In addition, the identification model generated based on the biometric information of the temporary registrant as described above is deleted from the storage unit 37, for example, after use.

Further, the switching of the identification model as described above can also be applied to, for example, authentication for a restricted area in an airport or boarding (embarkment) with respect to traffic facilities (a railway vehicle, an airplane, a ship, or the like). In such a case, not an identification model for normal use as described above but an identification model for temporary use is mainly used, and, for example, pieces of registrant information of temporary registrants based on a list of embarkment-scheduled persons (boarding-scheduled persons) of the traffic facilities such as an airplane are saved in the storage unit 25. The identification model for temporary use based on the pieces of registrant information is generated by the generation unit 22 for each traffic facility such as an airplane (in other words, each time zone for embarkment (boarding)), transmitted to the authentication device 3, and saved in the storage unit 37. Such an identification model in the storage unit 37 is associated with each attribute information depending on a related traffic facility (time zone). Then, the switching unit 38 outputs an attribute of a traffic system such as an airplane on which embarkment (boarding) has been started to the determination unit 33 while referring to operation schedule information of the airplane, for example, based on time information. The determination unit 33 executes the authentication process by using the identification model for temporary use to be used for the processing in a switched manner based on the information from the switching unit 38.

### Fourth Example Embodiment

Hereinafter, a fourth example embodiment will be described. In a description of the fourth example embodiment, portions with the same names as constituent portions constituting the authentication systems of the first to third example embodiments will be denoted by the same reference signs, and redundant descriptions of such common portions will be omitted.

In the fourth example embodiment, an iris is used as biometric information. The iris is different between a right eye and a left eye even for the same person. Using this, the authentication system 1 of the fourth example embodiment has a configuration to perform a plurality of authentication processes by performing an authentication process using the iris of the right eye and an authentication process using the iris of the left eye.

That is, for example, the generation unit 22 of the server 2 performs machine learning of a feature amount extracted from an image of the iris of the right eye as information on the possibility of entry of a gate GA, thereby generating an identification model for the gate GA (identification model for the right eye) that determines the entry permissibility of the gate GA. For example, the generation unit 22 performs machine learning of a feature amount extracted from an image of the iris of the left eye as information on the possibility of entry of a gate GB different from the gate GA, thereby generating an identification model for the gate GB (identification model for the left eye) that determines the entry permissibility of the gate GB.

In a case where the authentication device 3 is, for example, an authentication device that is commonly used for both the gate GA and the gate GB and has a function of determining the entry permissibility of both the gate GA and the gate GB, the storage unit 37 of the authentication device 3 stores the identification model for the gate GA and the identification model for the gate GB. That is, the transmission unit 24 of the server 2 transmits the identification model for the gate GA and the identification model for the gate GB generated by the generation unit 22 to the commonly used authentication device 3.

The acquisition device 5 connected to the authentication device 3 commonly used for both the gate GA and the gate GB is, for example, an image capturing device that captures irises of both eyes. In this case, the extraction unit 32 of the authentication device 3 extracts a feature amount of the iris of the right eye and the feature amount of the iris of the left eye from the image in which the irises of both the eyes are captured. The determination unit 33 determines whether a person to be authenticated is permitted to enter through the gate GA based on a feature amount of the iris of the right eye of the person to be authenticated using the identification model for the gate GA. The determination unit 33 further determines whether the person to be authenticated is permitted to enter through the gate GB based on the feature amount of the iris of the left eye of the person to be authenticated using the identification model for the gate GB.

For example, the output unit 34 transmits a determination result of the determination unit 33 regarding the gate GA to a predetermined destination such as the notification device 6 installed near the gate GA. For example, the output unit 34 further transmits a determination result of the determination unit 33 regarding the gate GB to a predetermined transmission destination such as the notification device 6 installed near the gate GB.

In a case where the authentication device 3 for the gate GA that determines the entry permissibility of the gate GA and the authentication device 3 for the gate GB that determines the entry permissibility of the gate GB are separate, the storage units 37 of the authentication devices 3 store the related identification models. That is, the transmission unit 24 of the server 2 transmits the identification model for the gate GA to the authentication device 3 for the gate GA and transmits the identification model for the gate GB to the authentication device 3 for the gate GB.

The acquisition device 5 connected to the authentication device 3 for the gate GA is, for example, an image capturing device, and captures at least an iris of a right eye. The extraction unit 32 of the authentication device 3 for the gate GA extracts a feature amount of the iris of the right eye from an image in which the iris of the right eye is captured. The determination unit 33 determines whether a person to be authenticated is permitted to enter through the gate GA based on a feature amount of the iris of the right eye of the person to be authenticated using the identification model for the gate GA. The output unit 34 transmits a determination result of the determination unit 33 regarding the gate GA to a predetermined destination such as the notification device 6 installed near the gate GA, for example.

The acquisition device 5 connected to the authentication device 3 for the gate GB is, for example, an image capturing device similar to the above, and captures at least an iris of a left eye. The extraction unit 32 of the authentication device 3 for the gate GB extracts a feature amount of the iris of the left eye from an image in which the iris of the left eye is captured. The determination unit 33 further determines whether a person to be authenticated is permitted to enter through the gate GB based on the feature amount of the iris of the left eye of the person to be authenticated using the identification model for the gate GB. The output unit 34 transmits a determination result of the determination unit 33 regarding the gate GB to a predetermined destination such as the notification device 6 installed near the gate GB, for example.

Configurations of the authentication system of the fourth example embodiment other than the above are similar to those of the first to third example embodiments, and the description thereof will be omitted.

Since the authentication system 1 of the fourth example embodiment has the configurations similar to those of the first to third example embodiments, effects similar to those of the first to third example embodiments can be obtained. In addition, the authentication system 1 of the fourth example embodiment is configured to perform mutually different types of authentication by separately using the iris of the right eye and the iris of the left eye of the same person. As a result, the authentication system 1 can perform a plurality of different types of authentications for the same person. An authentication process using a combination of a plurality of pieces of biometric information as described above may be performed, such as a combination of an iris of a right eye and another biometric information (for example, a face) or a combination of an iris of a left eye and the other biometric information (for example, a vein pattern). In such a case, for example, the identification model for the gate GA (identification model for the right eye) is generated by learning not only the iris of the right eye but also another biometric information (for example, the face). Similarly, the identification model for the gate GB (identification model for the left eye) is generated by learning not only the iris of the left eye but also another biometric information (for example, the vein pattern).

### Other Example Embodiments

This disclosure is not limited to the first and second example embodiments, and can adopt various example embodiments. For example, the configurations of the authentication system 1 have been described in the first to fourth example embodiments by exemplifying the case where the authentication system 1 is applied to the determination on whether to permit entry to a facility, but the authentication system 1 is also applicable to authentication other than the determination on whether to permit entry to the facility. However, the authentication device 3 of the authentication system 1 is configured not to have the personal information, and thus, the authentication system 1 is particularly effective in a case where it is possible to determine whether to authenticate a person to be authenticated without having the personal information of the person to be authenticated.

In addition to the configurations of the first to fourth example embodiments, the determination unit 33 of the authentication device 3 may be configured not only to determine whether to authenticate the person to be authenticated but also to output a description related to the determination. For example, the determination unit 33 outputs information on a determination result indicating that entry is permitted and information indicating a direction in which the person to be authenticated needs to advance (for example, information indicating turning right). The output unit 34 outputs the pieces of information on the determination result and the description by the determination unit 33 to a predetermined output destination such as the notification device 6. As a result, for example, the notification device 6 notifies the person to be authenticated of not only the determination result of the determination unit 33 but also the other information.

In the case where the determination unit 33 outputs not only the determination result but also the description as described above, the generation unit 22 of the server 2 generates an identification model by learning, for example, data in which the information regarding the description is annotated with a feature amount of biometric information of a registrant to be authenticated. When the identification model generated in this manner is used by the determination unit 33 of the authentication device 3, the determination unit 33 can not only determine whether to authenticate the person to be authenticated but also output the description.

Further, the example in which the generation unit 22 generates the identification model by performing the machine learning of the biometric information of the registrant permitted to enter has been described in the first to fourth example embodiments. Alternatively, the generation unit 22 may generate an identification model based on positive examples obtained by performing machine learning of biometric information (information on the positive examples) of registrants permitted to enter and an identification model based on negative examples obtained by performing machine learning of biometric information (information on the negative examples) of persons not permitted to enter. In this case, a ratio between the number of positive examples (the number of registrants permitted to enter) and the number of negative examples (the number of persons not permitted to enter) used for generation of the identification model is not limited, and may be, for example, a ratio such as the number of negative examples of 9000 relative to the number of positive examples of 1000.

In the case where the generation unit 22 generates the identification model based on the positive examples and the identification model based on the negative examples in this manner, the both are transmitted to the authentication device 3 together. The determination unit 33 of the authentication device 3 determines whether a person to be authenticated can enter using both the identification models. That is, in a case where the person to be authenticated is determined to be possible to enter by the identification model based on the positive examples and is determined not to be a person whose entry is prevented by the identification model based on the negative examples, the determination unit 33 permits the entry, that is, authenticates the person to be authenticated. In a case where the person to be authenticated is determined not to be a person who can enter by the identification model based on the positive examples and is determined to be a person whose entry is prevented by the identification model based on the negative examples, the determination unit 33 does not permit the entry, that is, does not authenticate the person to be authenticated. Further, in a case where the person to be authenticated is determined not to be a person who can enter by the identification model based on the positive examples but is determined not to be a person whose entry is prevented by the identification model based on the negative examples, the determination unit 33 determines that some kind of trouble has occurred. In this case, the determination unit 33 outputs an alarm, for example, instead of outputting a determination result as to whether authentication is possible for the person to be authenticated. Alternatively, the determination unit 33 outputs a determination result and an alarm indicating that authentication is not performed. Further, the determination unit 33 also determines that some kind of trouble has occurred in the same manner as described above in a case where the person to be authenticated is determined to be a person who can enter by the identification model based on the positive examples and is determined to be a person whose entry is prevented by the identification model based on the negative examples. Even in this case, the determination unit 33 outputs, for example, an alarm instead of outputting a determination result as to whether authentication is possible for the person to be authenticated, or outputs a determination result and an alarm indicating that authentication is not performed. Such an alarm or the like is output to the notification device 6 or the entry management system by the output unit 34 in the same manner as described above, whereby the occurrence of the trouble is notified.

Since the determination unit 33 uses both the identification model based on the positive examples and the identification model based on the negative examples to determine whether the person to be authenticated is permitted to enter (entry permissibility) as described above, the accuracy of the determination by the determination unit 33 can be enhanced.

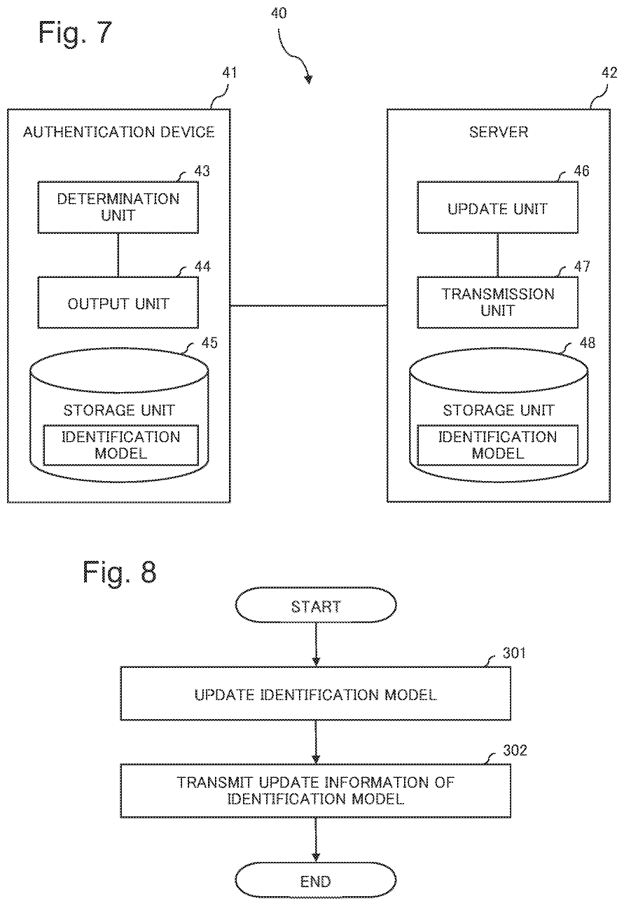

FIG. 7 is a block diagram illustrating minimum configurations of an authentication system according to this disclosure. An authentication system 40 includes an authentication device 41 and a server 42. In addition, the authentication device 41 includes a determination unit 43, an output unit 44, and a storage unit 45, and the server 42 includes an update unit 46, a transmission unit 47, and a storage unit 48. The storage unit 45 of the authentication device 41 stores an identification model. The identification model is a model generated by learning a feature amount extracted from biometric information of a registrant. The determination unit 43 determines whether to authenticate a person to be authenticated based on a feature amount extracted from biometric information of the person to be authenticated using the identification model of the storage unit 45. The output unit 44 outputs a determination result of the determination unit 43.

The storage unit 48 of the server 42 stores the same identification model as the identification model used by the authentication device 41. The update unit 46 updates the identification model of the storage unit 48 in response to a change of the registrant. The transmission unit 47 transmits update information of the identification model to the authentication device 41 in response to the update of the identification model.

FIG. 8 is a flowchart illustrating an example of an operation related to the update of the identification model in the server 42. For example, the server 42 holds the same identification model as the identification model used by the authentication device 41, and the update unit 46 of the server 42 executes the operation of updating the identification model when detecting that the registrant related to the identification model used by the authentication device 41 has changed. That is, the update unit 46 updates the same identification model as the identification model used by the authentication device 41 in response to the change of the registrant (Step 301 in FIG. 8). Then, the transmission unit 47 of the server 42 transmits update information of the updated identification model to the authentication device 41 (Step 302). In the authentication device 41 that has received the transmitted update information of the identification model, the identification model is updated based on the update information, and the determination unit 43 determines whether to authenticate the person to be authenticated based on the feature amount extracted from the biometric information of the person to be authenticated using the updated identification model.

In the authentication system 40, the storage unit 45 of the authentication device 41 stores the identification model, and the determination unit 43 uses the identification model of the storage unit 45 to determine whether to authenticate the person to be authenticated based on the feature amount extracted from the biometric information of the person to be authenticated. That is, the authentication device 41 is configured to be capable of determining whether to authenticate the person to be authenticated without having personal information of the person to be authenticated.

In the authentication system 40, the identification model is updated in the server 42 capable of having higher security than the authentication device 41 when the registrant has changed and the identification model needs to be updated. Then, the server 42 transmits update information regarding the updated identification model to the authentication device 41, whereby the identification model in the authentication device 41 is updated. Since such a configuration is provided, the authentication device 41 does not necessarily have the personal information of the registrant.in the authentication system 40 even if it is considered to update the identification model.

That is, the authentication system 40 is configured in such a way that the server 42 having higher security than the authentication device 41 has the personal information of the registrant and the authentication device 41 does not need to have the personal information, and thus, it is possible to reduce a risk of leakage of the personal information of the registrant.

In addition, the authentication device 41 is configured to determine whether to authenticate the person to be authenticated using the identification model held by the authentication device 41 that acquires the biometric information of the person to be authenticated in the authentication system 40, and communication does not need to be performed between the authentication device 41 and the server 42 in order to determine whether to authenticate the person to be authenticated. Thus, the authentication system 40 can shorten a response time of an authentication process during the authentication process as compared with a case where communication is performed between the authentication device and the server.

Accordingly, the authentication system 40 can reduce the risk of leakage of the personal information and shorten the response time of the authentication process.

The present invention has been described as above using the above-described example embodiments as exemplary examples. However, the present invention is not limited to the above-described example embodiments. That is, the present invention can apply various modes that can be understood by those skilled in the art within a scope of the present invention.

This application is based upon and claims the benefit of priority from Japanese patent application No. 2020-174754, filed on Oct. 16, 2020, the disclosure of which is incorporated herein in its entirety by reference.

### REFERENCE SIGNS LIST

1, 40 authentication system
2, 42 server
3, 41 authentication device
23, 46 update unit
24, 47 transmission unit
33, 43 determination unit
34, 44 output unit
38 switching unit

What is claimed is:

1. An authentication system comprising:
an authentication device including a storage and at least one processor, the storage storing a first identification model generated by learning a feature amount extracted from biometric information of a registrant, the at least one processor being configured to determine whether to authenticate a person to be authenticated using the first identification model based on a feature amount extracted from biometric information of the person to be authenticated and output a determination result; and
a server including a storage and at least one processor, the storage storing the same identification model as the first identification model used by the authentication device as a second model, the at least one processor being configured to update the second identification model in response to a change of the registrant and transmit update information of the second identification model to the authentication device.

2. The authentication system according to claim 1, wherein
a plurality of the registrants are classified into a plurality of classifications, and the storage of each of the authentication device and the server stores a plurality of identification model related to each of the classifications generated by learning the feature amount extracted from the biometric information of the registrant for each of the classifications instead of the first identification model and the second identification model, and
the at least one processor of the server updates a third identification model of the plurality of identification model, the third identification model is related to the classification for which the registrant has changed in response to the change of the registrant, and the at least one processor transmits the update information of the updated third identification model to the authentication device.

3. The authentication system according to claim 1, wherein
each of the first identification model and the second identification model is a model generated by learning feature amounts extracted from a plurality of pieces of biometric information of the registrant, and
the at least one processor of the authentication device determines whether to authenticate the person to be authenticated using the identification model based on the feature amounts respectively extracted from the plurality of pieces of biometric information of the person to be authenticated.

4. The authentication system according to claim 1,
wherein a plurality of the identification models in mutually different periods are stored in the storage of each of the authentication device and the server instead of the first identification model and the second identification model, and
the at least one processor of the authentication device is further configured to switch the identification model to be used by the determination of authentication based on time information.

5. The authentication system according to claim 1, wherein an iris is used as the biometric information.

6. The authentication system according to claim 5, wherein
each of the first identification model and the second identification model includes an identification model for a right eye generated by learning a feature amount based on an iris of a right eye that is the biometric information and an identification model for a left eye generated by learning a feature amount based on an iris of a left eye that is the biometric information, and
the at least one processor of the authentication device determines whether to authenticate the person to be authenticated using the identification model for the right eye based on a feature amount extracted from an image of an iris of a right eye of the person to be authenticated, and determines whether to authenticate the person to be authenticated using the identification model for the left eye based on a feature amount extracted from an image of an iris of a left eye of the person to be authenticated.

7. The authentication system according to claim 5, wherein
the identification model stored in the storage of the server includes an identification model for a right eye generated by learning a feature amount based on an iris of a right eye that is the biometric information, and an identification model for a left eye generated by learning a feature amount based on an iris of a left eye that is the biometric information,
the identification model for the right eye is stored in the storage of a first authentication device, which is at least one of a plurality of the authentication devices connected to the server, and the at least one processor of the first authentication device determines whether to authenticate the person to be authenticated using the identification model for the right eye based on a feature amount extracted from an image of an iris of a right eye of the person to be authenticated, and
the identification model for the left eye is stored in the storage of a second authentication device, which is at least one of the other authentication devices connected to the server and other than the first authentication device, and the at least one processor of the second authentication device determines whether to authenticate the person to be authenticated using the identification model for the left eye based on a feature amount extracted from an image of an iris of a left eye of the person to be authenticated.

8. An authentication method, executed by a computer, comprising:
updating a second identification model identical to a first identification model used by an authentication device that determines whether to authenticate a person to be authenticated based on a feature amount extracted from biometric information of the person to be authenticated using the first identification model generated by learning a feature amount extracted from biometric information of a registrant, in response to a change of the registrant;
transmitting update information of the second identification model to the authentication device; and
causing the first identification model to be updated based on the update information in the authentication device that has received the update information of the second identification model and the authentication device to determine whether to authenticate the person to be authenticated based on the feature amount extracted from biometric information of the person to be authenticated using the updated second identification model.

9. A non-transitory program storage medium storing a computer program that causes a computer to execute:
a process of updating a second identification model identical to a first identification model used by an authentication device that determines whether to authenticate a person to be authenticated based on a feature amount extracted from biometric information of the person to be authenticated using the first identification model generated by learning a feature amount extracted from biometric information of a registrant in response to a change of the registrant; and
a process of transmitting update information of the second identification model to the authentication device.
